(19) United States
(12) Patent Application Publication
(10) Pub. No.: US 2026/0135444 A1
(43) Pub. Date: May 14, 2026

(54) BRUSHLESS HOLLOW CUP MOTOR

(71) Applicant: AAC MICROTECH (CHANGZHOU) CO., LTD., Changzhou (CN)

(72) Inventors: Jinguo Wu, Changzhou (CN); Sensen Yang, Changzhou (CN); Feng Yan, Changzhou (CN); Junsheng Wang, Changzhou (CN)

(21) Appl. No.: 19/328,112

(22) Filed: Sep. 13, 2025

Related U.S. Application Data
(63) Continuation of application No. PCT/CN2024/131592, filed on Nov. 12, 2024.

(51) Int. Cl. H02K 11/01; H02K 5/02; H02K 5/04; H02K 7/08; H02K 11/215; H02K 21/14

(52) U.S. Cl. CPC H02K 11/0141; H02K 5/02; H02K 5/04; H02K 7/083; H02K 11/215; H02K 21/14; H02K 2211/03

(57) ABSTRACT

A brushless hollow cup motor includes a housing, a stator assembly fixed in the housing, and a rotor assembly supported in the housing and rotatably connected to the housing, in which the stator assembly is provided around the rotor assembly and spaced apart from the rotor assembly; the brushless hollow cup motor further includes a machine casing, which is fixedly sleeved on the housing, and the housing is made of a magnetically conductive material. The present application eliminates the silicon steel stacks, thereby increasing the internal magnetic circuit space. This allows for a larger magnetic steel volume, effectively enhancing the motor torque. By assembling a magnetically conductive housing externally, magnetic leakage can be reduced, further improving the performance of the brushless hollow cup motor. Additionally, the shape of the machine casing may be flexibly adjusted according to requirements, resulting in greater practicality and higher spatial utilization efficiency.

### CROSS-REFERENCE TO RELATED APPLICATIONS

This application is a continuation of International Application No. PCT/CN 2024/131592, Nov. 12, 2024, the entire contents of which are incorporated herein by reference.

### TECHNICAL FIELD

The present application relates to the field of motor technologies, in particular to a brushless hollow cup motor.

### BACKGROUND

The brushless hollow cup motor adopts a hollow-cup design that not only reduces weight but also enhances heat dissipation performance. With its rapid response speed and precise control, it has been widely applied in fields such as motors and generators. In recent years, the industrial sector has shown a growing demand for devices that use brushless hollow cup motors to directly drive loads. The widespread application of such direct-drive devices is expected to bring immense energy-saving benefits.

In related art, most of the traditional brushless hollow cup motors include a front cover, a rotor, a stator spaced around the rotor, and a back cover. The front cover and the back cover are set at opposite ends of the stator, and the rotation of the motor is realized by mutual driving of the stator and the rotor. The stator includes a housing fixed to the front cover and a winding fixed inside the housing, and the rotor generally includes a rotor shaft and a magnet fixed to an outer peripheral side of the rotor shaft, and the rotation of the motor is realized by mutual driving of the magnet and the winding. However, the traditional brushless hollow cup motor is often assembled with silicon steel sheet stacks on the inside of the housing body to achieve the purpose of reducing magnetic loss, but the presence of silicon steel sheet stacks significantly occupies the internal magnetic circuit space, limiting the size of the magnetic steel and subsequently affecting the motor's torque output. Additionally, the magnetic circuit design in current brushless hollow cup motors typically involves direct contact between the rotor shaft and the magnetic steel, which poses a certain risk of magnetic leakage. Moreover, when the axial hole of the magnetic steel is small, a complex manufacturing process is required to ensure the coaxiality of the inner and outer circles of the magnetic steel, resulting in high costs and challenges for mass production.

Therefore, it is necessary to provide a new brushless hollow cup motor to solve the above technical problems.

### SUMMARY

An object of the present application is to provide a brushless hollow cup motor, aiming at canceling the annular silicon steel sheet stacks in the traditional brushless hollow cup motor, releasing the magnetic circuit space, and assembling a housing of magnetically conductive material on the outer side of the housing, so as to effectively reduce the magnetic loss of the stator of the motor, and to improve the efficiency and performance of the brushless hollow cup motor as a whole.

In order to achieve the above purpose, the present application provides a brushless hollow cup motor including a housing, a rotor assembly supported at both ends of the housing and rotatably connected to the housing, and a stator assembly fixed in the housing, the stator assembly being provided around the rotor assembly and spaced apart from the rotor assembly;

wherein the brushless hollow cup motor further includes a machine casing, wherein the machine casing is provided outside the housing, a shape of an inner side of the housing is matched with an outer side of the housing, and the housing is made of a magnetically conductive material.

In an embodiment, the housing includes a hollow cylindrical housing body, a front cover fixed to one end of the housing body, a back cover fixedly connected to the other end of the housing body, and a circuit board fixed to a side of the back cover away from the housing body, wherein two ends of the rotor assembly are rotatably connected to the front cover and the back cover, respectively, and the housing is fixedly sleeved on the housing body.

In an embodiment, the housing body is made of a soft magnetic material.

In an embodiment, the rotor assembly includes a rotor shaft rotatably connected to the front cover and the back cover, an iron core fixedly sleeved on the rotor shaft, and a magnet fixedly sleeved on the iron core, wherein the magnet is spaced apart from the stator assembly.

In an embodiment, the front cover includes a fixing portion fixedly connected to the machine casing and a connecting portion formed by extending the fixing portion along an axial direction of the rotating shaft, wherein an outer periphery of the connecting portion is fixed within the housing body.

In an embodiment, the magnet is made of a hard magnetic material.

In an embodiment, the brushless hollow cup motor further includes a first bearing and a second bearing, wherein the first bearing is fixedly sleeved on an end of the rotating shaft close to the front cover, and an outer periphery of the first bearing is fixed within the front cover; the second bearing is fixedly sleeved on an end of the rotating shaft away from the front cover, and an outer periphery of the second bearing is fixed within the back cover.

In an embodiment, the iron core is made of a magnetically conductive material.

In an embodiment, the brushless hollow cup motor further includes a sensor assembly, which is configured to detect rotation data of the rotor shaft, and includes a sensor magnet fixedly sleeved on an end of the rotor shaft away from the second bearing and a Hall sensor fixed to a side of the circuit board close to the back cover, wherein the Hall sensor is arranged opposite to and spaced from the sensor magnet.

Compared with the related art, the brushless hollow cup motor of the present application includes a housing, a stator assembly fixed in the housing, and a rotor assembly supported in the housing and rotatably connected to the housing, in which the stator assembly is provided around the rotor assembly and spaced apart from the rotor assembly; the brushless hollow cup motor further includes a machine casing, which is fixedly sleeved on the housing, and the housing is made of a magnetically conductive material. The present application eliminates the silicon steel stacks in the traditional brushless hollow cup motors, thereby increasing the internal magnetic circuit space. This allows for a larger magnetic steel volume, effectively enhancing the motor torque. By assembling a magnetically conductive housing externally, magnetic leakage can be reduced, further improving the performance of the brushless hollow cup motor. Additionally, the shape of the machine casing may be flexibly adjusted according to requirements, resulting in greater practicality and higher spatial utilization efficiency.

### BRIEF DESCRIPTION OF THE DRAWINGS

In order to more clearly illustrate the technical solutions in the embodiments of the present application, the accompanying drawings that need to be used in the description of the embodiment will be briefly introduced as follows. Obviously, the accompanying drawings in the following description are only some of the embodiments of the present application, and for the person of ordinary skill in the field, other accompanying drawings may be obtained based on these drawings without putting forth any creative labor.

FIG. 1 shows a schematic diagram of a three-dimensional structure of a brushless hollow cup motor according to an embodiment of the present application.

FIG. 2 shows an exploded view of the three-dimensional structure of the brushless hollow cup motor according to an embodiment of the present application.

FIG. 3 is a sectional view of the brushless hollow cup motor of FIG. 1 along line A-A.

In the figures, 100, brushless hollow cup motor; 1, housing; 11, housing body; 12, front cover; 121, fixing portion; 122, connecting portion; 13, back cover; 2, stator assembly; 3, rotor assembly; 31, rotor shaft; 32, iron core; 33, magnet; 4, machine casing; 5, circuit board; 6, first bearing; 7, second bearing; 8, sensor assembly; 81, sensor magnet; and 82, Hall sensor.

### DETAILED DESCRIPTION OF THE EMBODIMENTS

The technical solutions in the embodiments of the present application will be described clearly and completely in the following in conjunction with the accompanying drawings in the embodiments of the present application. Obviously, the described embodiments are only a part of the embodiments of the present application and not all of the embodiments. Based on the embodiments in the present application, all other embodiments obtained by a person of ordinary skill in the art without making creative labor fall within the scope of protection of the present application.

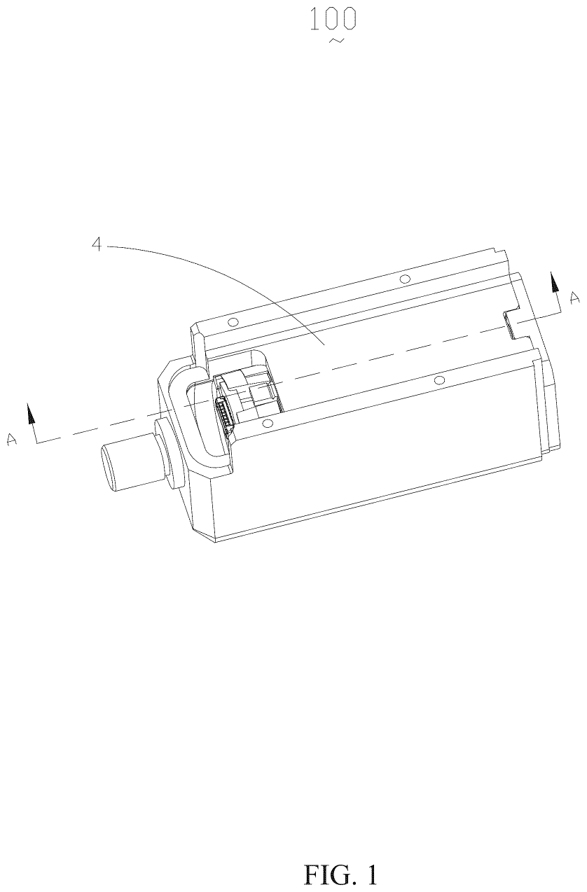

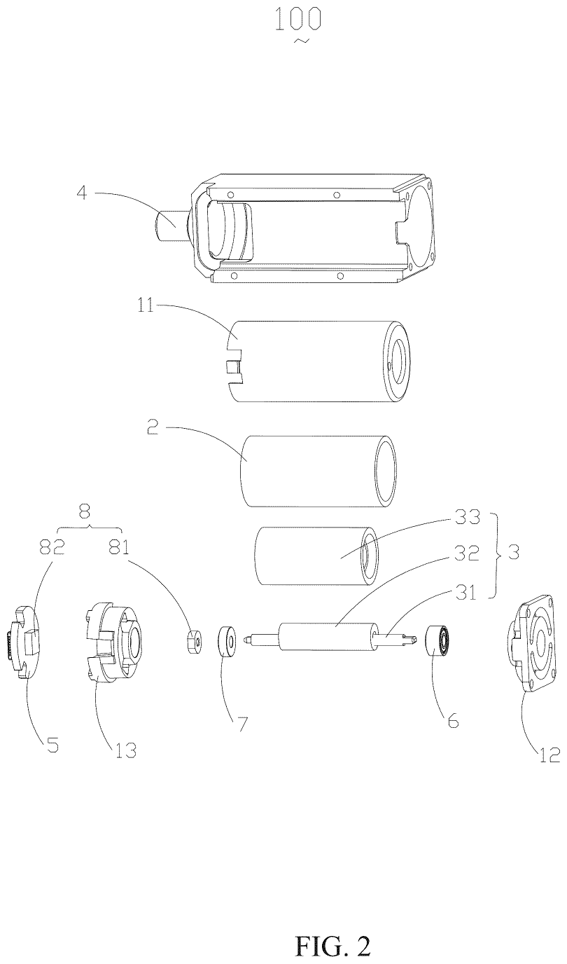

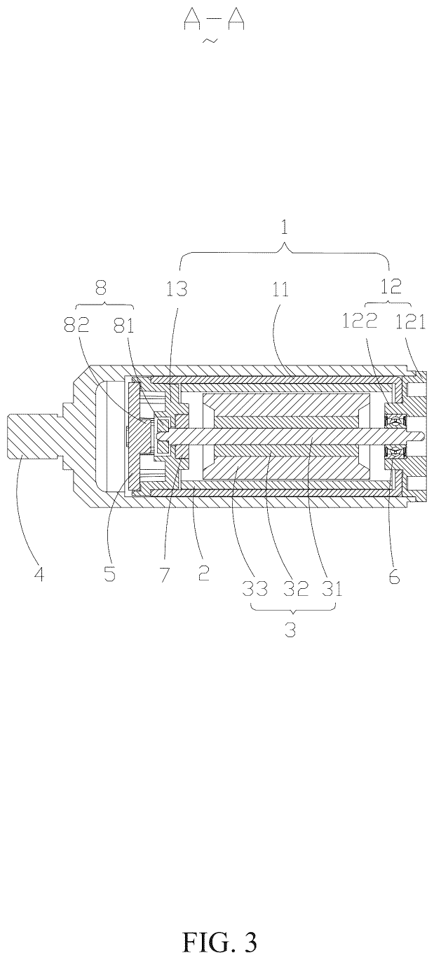

As shown in FIGS. 1 to 3, an embodiment of the present application provides a brushless hollow cup motor 100 including a housing 1, a stator assembly 2 fixed in the housing 1, and a rotor assembly 3 supported at both ends of the housing 1 and rotatably connected to the housing 1. The stator assembly 2 is provided around the rotor assembly 3 and spaced apart from the rotor assembly 3.

The brushless hollow cup motor 100 further includes a machine casing 4. The machine casing 4 is provided outside the housing 1, and the shape of the inner side of the machine casing 4 is matched with the outer side of the housing 1. The machine casing 4 is made of a magnetically conductive material. Specifically, by fixedly sleeving the machine casing 4 on the housing 1, as the machine casing 4 is made of a magnetically conductive material, magnetic leakage is reduced and the performance of the motor is improved. Besides, the shape of the machine casing 4 may be flexibly adjusted according to the requirements, resulting in greater practicality and higher spatial utilization efficiency.

In this embodiment, the housing 1 includes a hollow cylindrical housing body 11, a front cover 12 fixed to one end of the housing body 11, a back cover 13 fixedly connected to the other end of the housing body 11, and a circuit board 5 fixed to a side of the back cover 13 away from the housing body 1. The two ends of the rotor assembly 3 are rotatably connected to the front cover 12 and the back cover 13, respectively, and the machine casing 4 is fixedly sleeved on the housing body 11.

In this embodiment, the housing body 11 is of a soft magnetic material.

In this embodiment, the rotor assembly 3 includes a rotor shaft 31 rotatably connected to the front cover 12 and the back cover 13, an iron core 32 fixedly sleeved on the rotor shaft 31, and a magnet 33 fixedly sleeved on the iron core 32. The magnet 33 is spaced apart from the stator assembly 2.

In this embodiment, the iron core 32 is made of a magnetically conductive material. By adopting the iron core 32 as a magnetically conductive material, the magnetic loss of the rotor assembly 3 can be reduced and the efficiency and the performance of the brushless hollow cup motor 100 can be improved.

In this embodiment, the front cover 12 includes a fixing portion 121 fixedly connected to the machine casing 4 and a connecting portion 122 formed by extending the fixing portion 121 along an axial direction of the rotor shaft 31. The outer periphery of the connecting portion 122 is fixed within the housing body 11.

In this implementation, the magnet 33 is a hard magnetic material, effectively increasing the structural strength of the rotor assembly 2.

In this embodiment, the brushless hollow cup motor 100 further includes a first bearing 6 and a second bearing 7. The first bearing 6 is fixedly sleeved on an end of the rotor shaft 31 close to the front cover 12, and the outer periphery of the first bearing 6 is fixed within the front cover 12. The second bearing 7 is fixedly sleeved on an end of the rotor shaft 31 away from the front cover 12, and the outer periphery of the second bearing 7 is fixed within the back cover 13. Therefore, the rotational performance of the rotor assembly 3 is effectively enhanced.

In this embodiment, the brushless hollow cup motor 100 further includes a sensor assembly 8, which is configured to detect the rotation data of the rotor shaft 31. The sensor assembly 8 includes a sensor magnet 81 fixedly sleeved on an end of the rotor shaft 31 away from the second bearing 7 and a Hall sensor 82 fixed to a side of the circuit board 5 close to the back cover 13. The Hall sensor 82 is arranged opposite to and spaced from the sensor magnet 81.

Compared with the related art, the brushless hollow cup motor of the present application includes a housing, a stator assembly fixed in the housing, and a rotor assembly supported in the housing and rotatably connected to the housing, in which the stator assembly is provided around the rotor assembly and spaced apart from the rotor assembly; the brushless hollow cup motor further includes a machine casing, which is fixedly sleeved on the housing, and the housing is made of a magnetically conductive material. The present application eliminates the silicon steel stacks in the traditional brushless hollow cup motors, thereby increasing the internal magnetic circuit space. This allows for a larger magnetic steel volume, effectively enhancing the motor torque. By assembling a magnetically conductive housing externally, magnetic leakage can be reduced, further improving the performance of the brushless hollow cup motor. Additionally, the shape of the machine casing may be flexibly adjusted according to requirements, resulting in greater practicality and higher spatial utilization efficiency.

Described above are only embodiments of the present application, and it should be pointed out that, for the ordinary technical personnel in the field, improvements may also be made without departing from the premise of the concept of the present application, but these are all within the protection scope of the present application.

What is claimed is:

1. A brushless hollow cup motor, comprising:
a housing;
a rotor assembly supported at both ends of the housing and rotatably connected to the housing;
a stator assembly fixed in the housing, the stator assembly being provided around the rotor assembly and spaced apart from the rotor assembly; and
a machine casing, wherein the machine casing is provided outside the housing, a shape of an inner side of the housing is matched with an outer side of the housing, and the housing is made of a magnetically conductive material.

2. The brushless hollow cup motor of claim 1, wherein the housing comprises a hollow cylindrical housing body, a front cover fixed to one end of the housing body, a back cover fixedly connected to the other end of the housing body, and a circuit board fixed to a side of the back cover away from the housing body, wherein two ends of the rotor assembly are rotatably connected to the front cover and the back cover, respectively, and the housing is fixedly sleeved on the housing body.

3. The brushless hollow cup motor of claim 2, wherein the housing body is made of a soft magnetic material.

4. The brushless hollow cup motor of claim 3, wherein the rotor assembly comprises a rotor shaft rotatably connected to the front cover and the back cover, an iron core fixedly sleeved on the rotor shaft, and a magnet fixedly sleeved on the iron core, wherein the magnet is spaced apart from the stator assembly.

5. The brushless hollow cup motor of claim 4, wherein the front cover comprises a fixing portion fixedly connected to the machine casing and a connecting portion formed by extending the fixing portion along an axial direction of the rotating shaft, wherein an outer periphery of the connecting portion is fixed within the housing body.

6. The brushless hollow cup motor of claim 4, wherein the magnet is made of a hard magnetic material.

7. The brushless hollow cup motor of claim 4, further comprising a first bearing and a second bearing, wherein the first bearing is fixedly sleeved on an end of the rotating shaft close to the front cover, and an outer periphery of the first bearing is fixed within the front cover; the second bearing is fixedly sleeved on an end of the rotating shaft away from the front cover, and an outer periphery of the second bearing is fixed within the back cover.

8. The brushless hollow cup motor of claim 4, wherein the iron core is made of a magnetically conductive material.

9. The brushless hollow cup motor of claim 7, further comprising a sensor assembly, which is configured to detect rotation data of the rotor shaft, and comprises a sensor magnet fixedly sleeved on an end of the rotor shaft away from the second bearing and a Hall sensor fixed to a side of the circuit board close to the back cover, wherein the Hall sensor is arranged opposite to and spaced from the sensor magnet.
